(19) United States
(12) Patent Application Publication
(10) Pub. No.: US 2026/0355946 A1
(43) Pub. Date: Nov. 12, 2026

(54) SIX-AXIS PARALLEL ROBOT WITH COMPLIANT MOTION AND THE MOTION METHOD FOR USING THE SAME

(71) Applicant: DELTA ELECTRONICS, INC., Taoyuan City (TW)

(72) Inventors: Chun-Tse LEE, Taoyuan City (TW); Tzu-Wei HUANG, Taoyuan City (TW); Shi-Yu WANG, Taoyuan City (TW)

(21) Appl. No.: 19/373,399

(22) Filed: Oct. 29, 2025

(30) Foreign Application Priority Data
Apr. 30, 2025 (CN) 202510566417.2

(51) Int. Cl. B25J 9/16; B25J 9/00

(52) U.S. Cl. CPC B25J 9/1623; B25J 9/0069; B25J 9/1607; B25J 9/1633

(57) ABSTRACT

A six-axis parallel robot including a moving platform, a base, and six actuators connected between the moving platform and the base through joints is disclosed. The moving platform is set with a target posture and multiple resistant forces. Each actuator includes a linear motor and a driver, where each driver executes: calculating an inverse kinematics based on the target posture to obtain a linear displacement with each linear actuator to follow and generate correspondingly a position command; calculating a Jacobian matrix, and calculate force distribution for the six liner actuators to generate a force command based on the Jacobian matrix and the multiple resistant forces; controlling the linear motors based on the position and force commands to maintain the moving platform at the target posture; and, controlling the linear motors to perform compliant motion whenever encountering an external force exceeding one of the resistant forces.

### BACKGROUND OF THE DISCLOSURE

### Technical Field

The present disclosure relates to a six-axis parallel robot, and in particularly to an active six-axis parallel robot capable of compliant motion, and a motion method of the robot.

### Description of Related Art

In automated production lines assembly process, six-axis (also called as six-degree-of-freedom) parallel robots are often used to assist in assembly. Such robots generally include two types which are active robots and passive devices.

Active robots are equipped with active motors and can provide active compensations, thus being more frequently used compared to passive devices. However, active robots, due to their high rigidity (e.g., applying actuators implemented by DC motors paired with ball screws), cannot independently perform compliant motion when subjected to external forces. When performing contact-based process (such as components assembly), collisions or interferences often happen. If the active robots cannot provide timely compliant force feedback when collisions or interferences occur, it will cause the assembled components and the components to be assembled to collide directly, resulting in damage to the assembled components.

Generally, when using the active robots for contact-base process on a production line, additional sensors (such as force sensor, torque sensor, or camera) should be used for auxiliary control to indirectly perform the aforementioned compliant motion. However, such arrangement not only increases system complexity, but also raises the overall costs of the production line.

### SUMMARY OF THE INVENTION

The object of the present disclosure is to provide a six-axis parallel robot with compliant motion and motion method for using the same, which can implement compliant motion through structure and algorithm of the robot itself without arranging additional sensors.

In one of the exemplary embodiments, the six-axis parallel robot of the present disclosure includes:
a moving platform, having a first surface;
a base platform, having a second surface;
multiple first joint components, respectively arranged on the first surface;
multiple second joint components, respectively arranged on the second surface;
six linear actuators, respectively arranged between the moving platform and the base platform through the multiple first joint components and the multiple second joint component, each of the linear actuators respectively having a linear motor and a motor driver, wherein the moving platform has a target posture and multiple resistance forces with respect to multiple directions, and each of the motor drivers is respectively configured to execute following actions:
performing an inverse kinematics calculation based on the target posture to obtain a linear displacement for each of the linear actuators to follow with to maintain the moving platform at the target posture and generating a position command correspondingly;
calculating a Jacobina matrix based on the target posture;
calculating a force distribution of each of the six linear actuators based on the Jacobian matrix and the multiple resistance forces and generating a force command correspondingly;
controlling a corresponding linear motor based on the position command and the force command to maintain the moving platform at the target posture; and
controlling the corresponding linear motor to perform a compliant motion when the moving platform is subjected to an external force which exceeds one of the multiple resistance forces.

In one of the exemplary embodiments, the compliant motion method of the present disclosure is applied to the above six-axis parallel robot and includes the following steps:
performing an inverse kinematics calculation based on the target posture by each of the motor drivers to obtain a linear displacement for each of the linear actuators to follow with to maintain the moving platform at the target posture and generating a position command correspondingly;
calculating a Jacobina matrix based on the target posture by each of the motor drivers;
calculating a force distribution of each of the six linear actuators based on the Jacobian matrix and the multiple resistance forces by each of the motor drivers and generating a force command correspondingly;
controlling a corresponding linear motor based on the position command and the force command by each of the motor drivers to maintain the moving platform at the target posture; and
controlling each of the linear actuators to perform a compliant motion by each of the motor drivers when the moving platform is subjected to an external force which exceeds one of the multiple resistance forces.

Compared with related arts, the present disclosure applies active six-axis parallel robot to implement compliant motion without arranging additional sensors, so as to save the cost of the production line and obtain higher flexibility in operation.

### BRIEF DESCRIPTION OF THE DRAWINGS

FIG. 1 is a schematic diagram of the six-axis parallel robot of an embodiment according to the present disclosure.

FIG. 2 is a block diagram of the linear actuator of an embodiment according to the present disclosure.

FIG. 3 is a motion flowchart of an embodiment according to the present disclosure.

FIG. 4 is a schematic diagram showing a calculation of inverse kinematics of an embodiment according to the present disclosure.

FIG. 5 is a schematic diagram showing a force distribution of an embodiment according to the present disclosure.

### DETAILED DESCRIPTION

The present disclosure discloses a six-axis parallel robot with compliant motion (referred to as the six-axis parallel robot hereinafter). The six-axis parallel robot in the present disclosure is an active robot. Through modifying an actuator in the six-axis parallel robot to a linear actuator that uses a linear motor, the rigidity of the actuator is reduced. Also, based on the inherent reverse-drivable characteristic of the linear motor, when subjected to external forces, the linear actuator can provide translational and/or rotational compensation to perform compliant motion. Therefore, the problem of damage to components caused by the six-axis parallel robot being unable to perform compliant motion when performing assembly tasks and encountering collisions or interferences can be avoided.

On the other hand, the present disclosure executes algorithms. When performing the compliant motion, the six-axis parallel robot can actively detect the displacement and magnitude of force of each linear actuator when each linear actuator is pushed by an external force. Therefore, the compliant motion can be implemented without arranging additional sensors.

Six-axis generally refers to a robot achieving operation in six degrees of freedom (DoF) through the coordinated motion of six driving elements (i.e., six linear actuators 5 in the present disclosure). Therefore, the six-axis parallel robot in the present disclosure can also be called as a six-degree-of-freedom parallel robot. For the ease of understanding, the description below will uniformly use the term “six-axis parallel robot”, but not limited thereto.

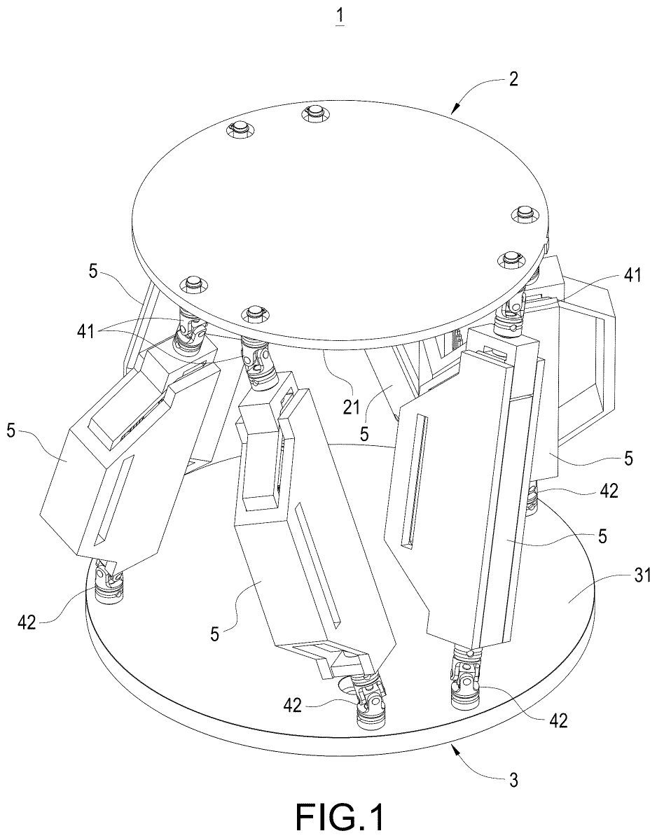

Please refer to FIG. 1, which is a schematic diagram of the six-axis parallel robot of an embodiment according to the present disclosure. FIG. 1 shows the structure of the six-axis parallel robot 1 of the present disclosure. As shown in FIG. 1, the six-axis parallel robot 1 of the present disclosure includes a moving platform 2, a base platform 3, multiple first joint components 41, multiple second joint components 42, and six linear actuators 5. The moving platform 2 is arranged with respect to the base platform 3, wherein the moving platform 2 has a first surface 21 in the direction toward the base platform 3 and the base platform 3 has a second surface 31 in the direction toward the moving platform 2. The amount of the multiple first joint components 41 is six, where the six first joint components 41 are respectively arranged on the first surface 21 of the moving platform 2. The amount of the multiple second joint components 42 is six, where the six second joint components 42 are respectively arranged on the second surface 31 of the base platform 3.

The linear actuator 5 is elongated. One end of each of the six linear actuators 5 respectively connects with one of the first joint components 41, another end of each of the six linear actuators 5 respectively connects with one of the second joint components 42. Therefore, the six linear actuators 5 are respectively arranged between the moving platform 2 and the base platform 3 through the six first joint components 41 and the six second joint components 42.

In one of the exemplary embodiments, the base platform 3 is set on a relatively stable position (for example, fixed on the ground or other supporting structure), while the moving platform 2 is a movable component of the six-axis parallel robot 1 which can be installed with an end effector. When using the six-axis parallel robot 1 to perform contact-base assembly processes, the moving platform 2 may be subjected to an external force. One technical feature of the present disclosure is that, the six-axis parallel robot 1 can analyze the external force through only using the six linear actuators 5 and an internal algorithm without any additional sensor, and the linear actuators 5 can be controlled to perform the compliant motion (detailed described in the following).

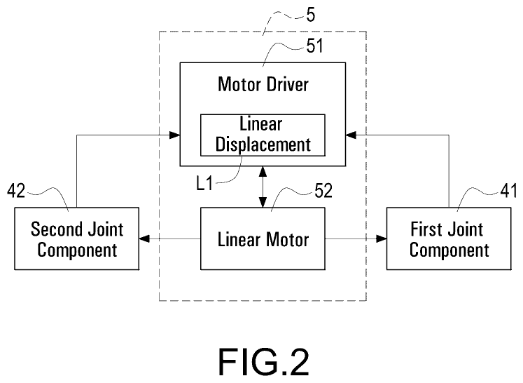

Please refer to FIG. 2 at the same time, wherein FIG. 2 is a block diagram of the linear actuator of an embodiment according to the present disclosure. As shown in FIG. 2, every linear actuator 5 in the present disclosure includes a motor driver 51 and a linear motor 52. The motor driver 51 connects to the linear motor 52 and controls the linear motor 52 to rotate through control commands. The linear motor 52 connects to a corresponding one of the first joint components 41 and a corresponding one of the second joint components 42 respectively at two ends of the linear actuator 5. When the linear motor 52 rotates, the first joint component 41 and/or the second joint component 42 can be brought by the linear motor 52 to rotate, thereby maintaining the moving platform 2 to be at a required target posture. The motor driver 51 can be connected to the first joint component 41 and the second joint component 42 as well. When the moving platform 2 is subjected to an external force, the motor driver 51 analyzes the external force in accordance with the angle change of the first joint component 41 and the second joint component 42 as well as the displacement change of the linear motor 52.

In the present disclosure, the six-axis parallel robot 1 maintains the moving platform 2 to be at a preset target posture after being actuated. When the moving platform 2 is maintained at the target posture, the six linear actuators 5 respectively operate at an individual preset linear displacement L1. In one embodiment, these linear displacements L1 are calculated based on a required target posture. On the other hand, the six-axis parallel robot 1 can, based on the user operation, set multiple resistance forces for the moving platform 2 relative to multiple directions (e.g., movement directions along X axis, Y axis, or Z axis, or rotation directions along X axis, Y axis, or Z axes). One technical feature of the present disclosure is that, when the moving platform 2 is subjected to an external force which does not exceed any of the resistance forces, each of the motor driver 51 continuously controls each of the linear motors 52 to operation at each individual linear displacement L1 for the moving platform 2 to be maintained at the target posture; when the moving platform 2 is subjected to an external force which exceeds any of the resistance forces, each of the motor driver 51 respectively controls each of the linear motors 52 to retract to achieve the compliant motion.

In one of the exemplary embodiments, the six-axis parallel robot 1 performs an analysis computation as described below through each motor driver 51 of each linear actuator 5. In another embodiment, the six-axis parallel robot 1 performs the analysis computation as described below through one or more controllers (not shown in the FIGS.) and generates commands to control each of the motor drivers 51 after the analysis computation. For the ease of understanding, below in the specification takes each motor driver 51 to perform an algorithm to analyze the external force as an example for interpretation, but not limited thereto.

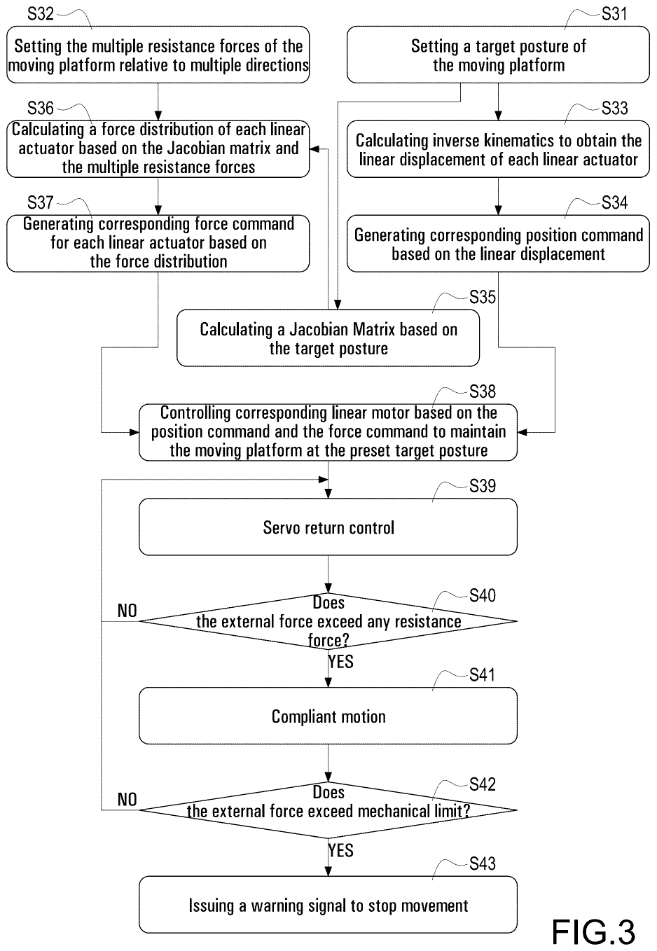

Please refer to FIG. 3 at the same time, wherein FIG. 3 is a motion flowchart of an embodiment according to the present disclosure. First, the six-axis parallel robot 1 receives an external operation through a human-machine interface (not shown) to set a target posture of the moving platform 2 (step S31). In addition, the six-axis parallel robot 1 can be set with the multiple resistance forces of the moving platform 2 relative to multiple directions through the external operation (step S32). In one embodiment, the resistance forces include three-axis forces and three-axis torques in the Cartesian coordinate system. The three axes include the X-axis, the Y-axis, and the Z-axis.

Next, each motor driver 51 performs a calculation of inverse kinematics based on the target posture of the moving platform 2 to obtain the linear displacement L1 that each linear actuator 5 needs to follow for maintaining the moving platform 2 at the target posture (step S33). In one embodiment, the six-axis parallel robot 1 obtains the linear displacement L1 of each linear actuator 5 and stores the linear displacement L1 of each linear actuator 5 in each corresponding motor driver 51 after the user sets the target posture of the moving platform 2. In another embodiment, the user can directly set the linear displacement L1 for each linear actuator 5 and store the linear displacement L1 of each linear actuator 5 to each corresponding motor driver 51.

The target posture being set in the step S31 is a posture on the Cartesian coordinate system. To control each of the linear motors 52, the six-axis parallel robot 1 first transforms the target posture into the linear displacements L1, and then each motor driver 51 respectively generates corresponding position command based on each corresponding linear displacement L1 (step S34). When each motor driver 51 respectively controls each corresponding linear motor 52 to rotate according to each position command, the six linear actuators 5 can maintain the moving platform 2 at the target posture.

On the other hand, the multiple resistance forces being set in the step S32 are forces on right-angle Cartesian coordinate system. To control each of the linear motors 52, the six-axis parallel robot 1 must transform the resistance forces into force commands. In one embodiment, each motor driver 51 calculates a Jacobian Matrix based on the target posture (step S35), then calculates a force distribution of the six linear actuators 5 based on the Jacobian matrix and the multiple resistance forces (step S36), and then generates the force command for each linear actuator 5 based on the force distribution (step S37), thereby obtaining a force threshold of each linear motor 52.

More specifically, the Jacobian matrix is used to describe a relationship between a robot joint space and a Cartesian space of an end effector of the moving platform 2. Therefore, the force distribution of each of the linear actuators 5 can be calculated in accordance with the posture and the resistance forces of the moving platform 2. The force distribution can be stored in each of the motor drivers 51. The detailed description of the Jacobian matrix will be interpreted in the following paragraphs.

After the step S34 and the step S37, the six-axis parallel robot 1 respectively obtains the corresponding position command and corresponding force command for each of the six linear actuators 5 (as well as the force threshold of each linear actuator 5). In the meantime, each motor driver 51 respectively controls its corresponding linear motor 52 to rotate based on its corresponding position command and its corresponding force command, thereby maintaining the moving platform 2 to be at the preset target posture (step S38). Also, each motor driver 51 continuously performs servo return control during the operation of the six-axis parallel robot 1 (step S39).

In particularly, when the moving platform 2 is subjected to an external force, the six-axis parallel robot 1 determines, through each of the motor drivers 51, whether the external force exceeds any of the resistance forces (step S40). For example, if the external force exceeds the force threshold of any of the linear actuators 5. In responsive to the moving platform 2 not subjected to an external force or the external force not exceeding any of the resistance forces, the six-axis parallel robot 1 maintains the moving platform 2 at the target posture. When the moving platform 2 is subjected to an external force which exceeds any of the resistance forces, each of the motor drivers 51 reverse-drives the corresponding linear motor 52 to achieve the compliant motion (step S41). To be more specific, when the external force exceeds the force threshold of any of the linear actuators 5, the motor driver 51 of this linear actuator 5 reverse-drives the linear motor 52 of this linear actuator 5 to achieve the compliant motion.

During the process that the moving platform 2 is subjected to the external force, each of the motor drivers 51 continuously monitors the variation of the linear displacement L1 of each linear motor 52. When the external force disappears or the external force varies to not exceeding the resistance forces, each of the motor drivers 51 immediately controls each corresponding linear motor 52 to rotate based on the position command and the force command to restore the moving platform 2 to the target posture. Therefore, the aforementioned servo return control can be achieved.

As mentioned above, when determining that the external force exceeds any of the resistance forces, each of the motor drivers 51 reverse-drives the corresponding linear motor 52 to achieve the complaint motion. However, every linear actuator 5 (i.e., every linear motor 52) has its mechanical limits and cannot be unlimited retrack. In some embodiment, each of the motor drivers 51 continuously monitors the variation of the linear displacement of each corresponding linear motor 52 when performing the compliant motion and determines whether the external force exceeds its mechanical limits (step S42). If the current complaint motion not yet reaches or exceeds its mechanical limit, each motor driver 51 controls each corresponding linear actuator 5 to continuously perform the complaint motion (i.e., goes back to the step S39). When determining that the current compliant motion has exceeded or is about to exceed its mechanical limits, each motor driver 51 issues a warning signal to stop further movement (step S43), thereby preventing the six-axis parallel robot 1 from being damaged due to the compliant motion. It should be mentioned that the system or each motor driver 51 may further issue a command to other devices in the system (such as a robotic arm being utilized with the six-axis parallel robot 1) to stop the other devices, so as to avoid collision or other risks.

In particularly, when performing the servo return control (i.e., the step S39 through the step S43), each motor driver 51 continuously monitors the variation of the linear displacement of each corresponding linear motor 52 and determines whether the external force currently subjected by the moving platform 2 exceeds the force threshold of each linear actuator 5 based on the variation. When determining that the external force exceeds the force threshold of any of the linear actuators 5, each motor driver 51 respectively controls each corresponding linear motor 52 to retract to achieve the compliant motion. Meanwhile, each motor driver 51 continuously monitors whether such a variation of the linear displacement of each corresponding linear motor 52 exceeds a preset mechanical threshold. In one embodiment, the mechanical threshold is corresponding to the mechanical limits of each linear motor 52.

Before the variation exceeds the mechanical threshold, each motor driver 51 allows each corresponding linear motor 52 to retract to keep performing the compliant motion. When the variation of the linear displacement of any of the linear motors 52 exceeds its mechanical threshold, each motor driver 51, in order to prevent the linear actuators 5 from being damaged, immediately issues a warning signal to stop further movement. In one embodiment, the warning signal is issued by each motor driver 51 to directly control each corresponding linear motor 52 to stop rotating. In another embodiment, the warning signal is issued for the controller of the system or the production line (not show), thereby the controller can control the six-axis parallel robot 1 to stop moving, or control the source of the external force to stop moving.

Through the aforementioned steps, the six-axis parallel robot 1 of the present disclosure can determine whether to perform the compliant motion when the moving platform 2 is subjected to an external force. When performing the compliant motion, the six-axis parallel robot 1 can continuously monitor the variation of displacement of each linear actuator 5, thereby preventing the six-axis parallel robot 1 from being damaged when the compliant motion exceeds the mechanical limits of the linear actuators 5.

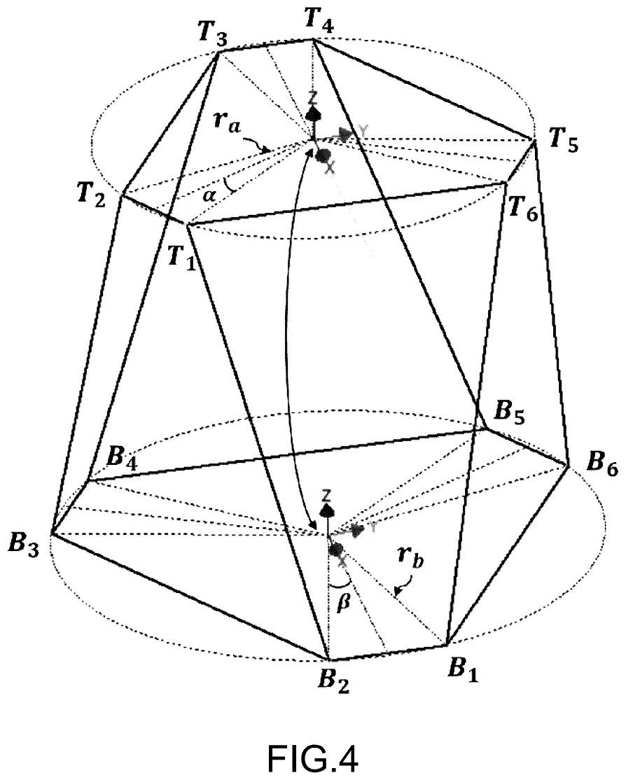

Please refer to FIG. 4, which is a schematic diagram showing a calculation of inverse kinematics of an embodiment according to the present disclosure. As mentioned above, the target posture of the moving platform 2 set by the user is a posture on Cartesian coordinate system. Therefore, the target posture should be first transformed into the position commands being used to directly control each of the linear motors 52. In one embodiment, the present disclosure applies inverse kinematics to perform the transformation.

As shown in FIG. 4, first, the structure of the six-axis parallel robot 1 should be defined. The definition includes the target posture of the moving platform 3 relative to a base platform coordinate system used by the base platform 3 (i.e., the target posture inputted in the step S31), a first distance rₐ between a central point of the moving platform 2 and each of the first joint components 41, a second distance r_{b} between a central point of the base platform 3 and each of the second joint components 42, a first angle α representing half the value of the angle between two closest first joint components 41 on the moving platform 2, and a second angle β representing half the value of the angle between two closest second joint components 42 on the base platform 3. In the present disclosure, the controller or each of the motor drivers 51 performs calculation through inputting the aforementioned information into an inverse kinematics formula.

Next, based on inverse kinematics, the controller or each of the motor drivers 51 calculates second coordinate positions B₁~B₆ of each second joint component 42 on the base platform coordinate system based on the second distance r_{b} and the second angle β, wherein the calculation formula is:

$$B 1 = [ {r}_{b} cos ( β ) , {r}_{b} sin ( β ) , 0 ] ;$$

$$B 2 = [ {r}_{b} cos ( - β ) , {r}_{b} sin ( - β ) , 0 ] ;$$

$$B 3 = [ {r}_{b} cos ( \frac{- 2 π}{3} + β ) , {r}_{b} sin ( \frac{- 2 π}{3} + β ) , 0 ] ;$$

$$B 4 = [ {r}_{b} cos ( \frac{- 2 π}{3} - β ) , {r}_{b} sin ( \frac{- 2 π}{3} - β ) , 0 ] ;$$

$$B 5 = [ {r}_{b} cos ( \frac{- 4 π}{3} + β ) , {r}_{b} sin ( \frac{- 4 π}{3} + β ) , 0 ] ;$$

$$B 6 = [ {r}_{b} cos ( \frac{- 4 π}{3} - β ) , {r}_{b} sin ( \frac{- 4 π}{3} - β ) , 0 ] .$$

Next, the controller or each of the motor drivers 51 further calculates first coordinate positions T₁~T₆ of each first joint component 41 on the base platform coordinate system based on the first distance rₐ and the first angle α. It should be mentioned that, the first coordinate positions T₁~T₆ being calculated have not passed the coordinate transformation procedure, so these positions are not actual positions of the multiple first joint components 41. The calculation formula for the first coordinate positions T₁~T₆ is:

$$T 1 = [ {r}_{a} cos ( \frac{- π}{3} + α ) , {r}_{a} sin ( \frac{- π}{3} + α ) , 0 ] ;$$

$$T 2 = [ {r}_{a} cos ( \frac{- π}{3} - α ) , {r}_{a} sin ( \frac{- π}{3} - α ) , 0 ] ;$$

$$T 3 = [ {r}_{a} cos ( - π + α ) , {r}_{a} sin ( - π + α ) , 0 ] ;$$

$$T 4 = [ {r}_{a} cos ( - π - α ) , {r}_{a} sin ( - π - α ) , 0 ] ;$$

$$T 5 = [ {r}_{a} cos ( \frac{- 5 π}{3} + α ) , {r}_{a} sin ( \frac{- 5 π}{3} + α ) , 0 ] ;$$

$$T 6 = [ {r}_{a} cos ( \frac{- 5 π}{3} - α ) , {r}_{a} sin ( \frac{- 5 π}{3} - α ) , 0 ] .$$

Next, the controller or each of the motor drivers 51 further performs coordinate transformation matrix multiplication on the first coordinate positions T₁~T₆ of each first joint component 41 in sequence, based on the target posture of the moving platform 2 relative to the base platform coordinate system, and then calculates the Euclidean Distance between the transformed coordinate position of each first joint component 41 and its corresponding second joint component 42, to obtain the corresponding linear displacement L1 of each corresponding linear actuator 5. The detailed formula is:
for i=0 to 5 do:

\vec{T}_{i,temp}=H_{4×4}·T[i];

l_{leg}=∥B[i+1]−\vec{T}_{i,temp}∥;

\vec{l}[i]=l_{leg};

Wherein, H_{4×4} represents the Homogeneous transformation matrix of transforming the target posture [X Y Z A B C]^{T}, T[i] represents the first coordinate position of each first joint component 41 relative to the base platform coordinate system, l_{leg} represents the linear displacement L1 of each linear actuator 5, \vec{l}[i] represents the aggregation of the linear displacements L1 of the six linear actuators 5.

Through using the aforementioned inverse kinematics calculation, the controller or each of the motor drivers 51 may transform the target posture of the moving platform 2 set by the user into the linear displacements L1 of the linear actuators 5. Therefore, the controller or each of the motor drivers 51 can generate the position commands used to control each of the linear motors 52 based on the linear displacements L1.

On the other hand, in addition to generating the linear displacements L1 based on the target posture, the controller or each of the motor drivers 51 further generates a Jacobian matrix based on the target posture (such as executing the aforementioned step S35).

In the present disclosure, the Jacobian matrix is a 6×6 matrix arranged with [X Y Z A B C]^{T} as the first-order partial derivatives. Assuming J is the Jacobian matrix, then it can be defined as [symbol] =J [symbol] , wherein [symbol] =[\dot{X} \dot{Y} Ż \dot{A} \dot{B} Ċ]^{T}, representing the Cartesian coordinate system of linear velocity of the moving platform 2 (end effector); [symbol] =[i₁ i₂ i₃ i₄ i₅ i₆]^{T}, representing the linear velocities of each linear actuator 5. Wherein, X, Y, and Z in the Jacobian matrix represent the position of each end point of the moving platform 2 on the Cartesian coordinate system, including the X representing the position on the X-axis, Y representing the position on the Y-axis, and Z representing the position on the Z-axis; A, B, C represent the orientation of each end point of the moving platform 2, for example, A, B, and C respectively represent Roll, Pitch, and Yaw in Euler Angles. T represents transpose.

First, the controller or each of the motor driver 51 inputs the target posture of the moving platform 2 and inputs a preset minute gain change amount (Incrementₛₘₐₗₗ), this minute gain change amount may be, for example but not limited to, 0.1 or 0.2, etc. Next, the controller or each of the motor driver 51 creates a posture array [X Y Z A B C]^{T}, and designates any value in the posture array as the minute gain change amount.

For example, the controller or each of the motor driver 51 creates a posture array such as [0 0 0 0 0 0]^{T}, and designates the value of any matrix element (such as the first element) in this posture array as the preset minute gain change amount (such as 0.1), so a posture array [0.1 0 0 0 0 0]^{T} can be obtained. Wherein, 0.1 is the value of the ith matrix component \vec{X}_{inc} (wherein i=1~6).

Next, the controller or each of the motor drivers 51 respectively calculates a linear displacement before changing of each linear actuator 5 under the target posture through inverse kinematics (i.e., \vec{I}_{before}=Inverse Kinematcis (Pos_{now})), and adds the current posture with the minute gain change amount to generate a changed posture, and then calculates a linear displacement post changing of each linear actuator 5 under the changed posture (i.e., \vec{l}_{after}=Inverse Kinematcis (Pos_{now}+[Increment small, 0,0,0,0,0]^{T})). Next, the controller or each of the motor drivers 51 calculates a difference between the linear displacement before changing and the linear displacement post changing (i.e., \vec{l}=\vec{l}_{after}−\vec{l}_{before}, wherein \vec{l} is the difference), and finally, using this difference and the value of the matrix element in the posture array after the minute gain change amount being added to calculate the final value of the corresponding matrix element in the Jacobian matrix.

Taking the above Jacobian matrix J as an example, [symbol] =J [symbol] is:

$$[ \begin{matrix}X \\ Y \\ Z \\ A \\ B \\ C\end{matrix} ] = [ \begin{matrix}{J}_{1 ( 1 X 6 )} \\ 0 \\ 0 \\ 0 \\ 0 \\ 0\end{matrix} ] [ \begin{matrix}{i}_{1} \\ {i}_{2} \\ {i}_{3} \\ {i}_{4} \\ {i}_{5} \\ {i}_{6}\end{matrix} ] ,$$

wherein J_{1(1×6)} is the value of the matrix element of the posture matrix being added with the minute gain change amount.

Finally, the controller or each of the motor drivers 51 repeatedly executes the aforementioned actions for six times, until the final values of all the six matrix elements in the Jacobian matrix are obtained. In particularly, the controller or each of the motor drivers 51 can obtain a 1×6 matrix element (i.e., J_{1(1×6)}) by executing the aforementioned actions for one time. After the aforementioned actions are executed for six times, six 1×6 matrix elements are obtained. After stacking these six matrix elements, a complete 6×6 Jacobian matrix can be obtained. By using the Jacobian matrix, the present disclosure can transform the resistance forces of the moving platform 2 relative to each direction into the force distribution of each of the linear actuators 5, thereby generating the force commands of controlling each of the linear motors 52 and obtaining the force thresholds of each of the linear actuators 5.

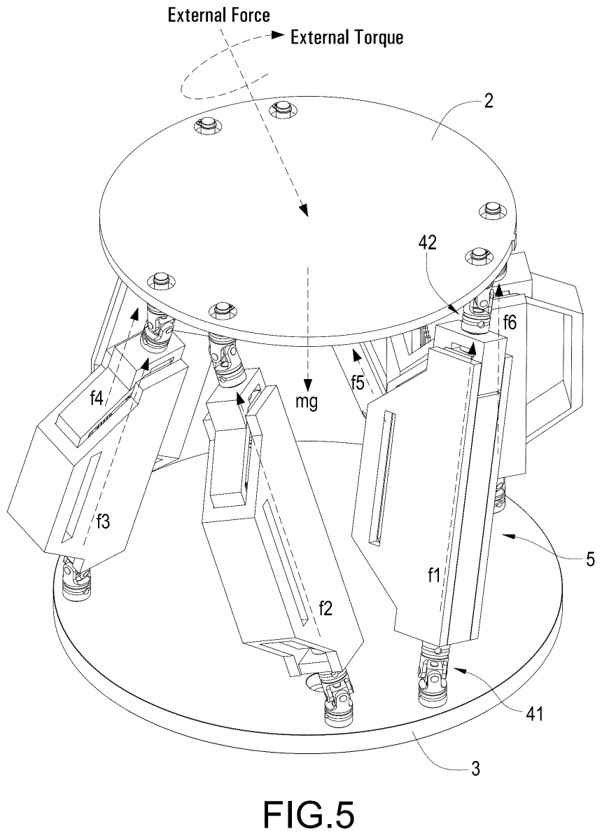

Please refer to FIG. 5 at the same time, wherein FIG. 5 is a schematic diagram showing a force distribution of an embodiment according to the present disclosure. FIG. 5 is used to detailed interpret how the present disclosure calculates the force distribution of each linear actuator 5 based on the resistance forces of the moving platform 2 and the Jacobian matrix.

First, the controller or each of the motor driver 51 obtains the values of multiple parameters required for calculation, include but not limited to the equivalent total mass m of the moving platform 2, the equivalent centroid vector \vec{xₘ} of the moving platform 2, the X-axis direction component F_{m,x}, the Y-axis direction component F_{m,y}, and the Z-axis direction component F_{m,z} of the equivalent external force on the moving platform 2, the equivalent torque vector Tₘ on the moving platform 2, and the vector matrix F formed by the equivalent external force and the equivalent torque vector. Moreover, the above parameters can be obtained through calculation by the controller or each of the motor drivers 51 after the initial setting is completed.

Next, the controller or each of the motor drivers 51 obtains the current posture of the moving platform 2 (i.e., the target posture) and the linear displacement L1 of each linear actuator 5 to calculate the Jacobian matrix. The calculation approach for the Jacobian matrix is same as or similar to the above, detailed description is omitted here. Or, the controller or each of the motor drivers 51 can directly uses the above Jacobian matrix which is calculated completely without calculating another Jacobian matrix.

Next, the controller or each of the motor drivers 51 calculates linear thrust vectors required for each of the linear actuators 5 to maintain the moving platform 2 at the target posture based on the following first formula:

f=J^{T}F=J^{T}(F+ [symbol] ×m\vec{g}) first formula;

Wherein, f represents the linear thrust vector of each linear actuator 5, J^{T} represents the Jacobian matrix, F represents the vector matrix, \vec{xₘ} represents the equivalent centroid vector of the moving platform 2, m represents the equivalent total mass of the moving platform 2, \vec{g} represent a gravitational vector. To be more specifically, the first formula can be further extended as the following second formula:

$$[ \begin{matrix}{f}_{1} \\ {f}_{2} \\ {f}_{3} \\ {f}_{4} \\ {f}_{5} \\ {f}_{6}\end{matrix} ] = JF = [ \begin{matrix}{J}_{1 ( 1 X 6 )} \\ {J}_{2 ( 1 X 6 )} \\ {J}_{3 ( 1 X 6 )} \\ {J}_{4 ( 1 X 6 )} \\ {J}_{5 ( 1 X 6 )} \\ {J}_{6 ( 1 X 6 )}\end{matrix} ] [ \begin{matrix}{F}_{x} \\ {F}_{y} \\ {F}_{z} - mg \\ {T}_{x} - mgy \\ {T}_{y} + mgx \\ {T}_{z}\end{matrix} ] … … second formula ;$$

Wherein, f1~f6 represent the linear thrust vectors of each of the linear actuators 5, J_{1 (1×6)}~J_{6 (1×6)} represent the value of each of the matrix elements in the Jacobian matrix, F_{X}, F_{Y}, and F_{Z} represent the equivalent forces on the moving platform 2, T_{X}, T_{Y}, and T_{Z} represent the equivalent torque vectors on the moving platform 2.

As shown in FIG. 5, the symbols f1~f6 respectively represent one linear thrust vector of each of the six linear actuators 5. These six linear thrust vectors f1~f6 can be used to represent the force distribution of each of the linear actuator 5 when the moving platform 2 is subjected to an external force (i.e., mg). Through calculating the force distribution of each of the linear actuators 5, the controller or each of the motor drivers 51 can generates the force commands respectively applicable to each linear motor 52. Besides, based on the linear thrust vectors of the six linear actuators 5, the controller or each of the motor drivers 51 can set the force thresholds for each of the linear actuators 5. Therefore, when the moving platform 2 is subjected to an external force and the force to any of the linear actuators 5 exceeds its force threshold, the corresponding motor driver 51 will be triggered to start performing the compliant motion.

By using the technical solution of the present disclosure, the six-axis parallel robot can achieve compliant motion without arranging additional sensors, so that the overall cost can be saved and the high flexible operation can be implemented.

What is claimed is:

1. A six-axis parallel robot with compliant motion, comprising:
a moving platform, having a first surface;
a base platform, having a second surface;
multiple first joint components, respectively arranged on the first surface;
multiple second joint components, respectively arranged on the second surface;
six linear actuators, respectively arranged between the moving platform and the base platform through the multiple first joint components and the multiple second joint component, each of the linear actuators respectively comprising a linear motor and a motor driver, wherein the moving platform has a target posture and multiple resistance forces relative to multiple directions, and each of the motor drivers is respectively configured to execute following actions:
action a) performing an inverse kinematics calculation based on the target posture to obtain a linear displacement for each of the linear actuators to follow with to maintain the moving platform at the target posture and generating a position command correspondingly;
action b) calculating a Jacobina matrix based on the target posture;
action c) calculating a force distribution of each of the six linear actuators based on the Jacobian matrix and the multiple resistance forces and generating a force command correspondingly;
action d) controlling a corresponding linear motor based on the position command and the force command to maintain the moving platform at the target posture; and
action e) controlling the corresponding linear motor to perform a compliant motion when the moving platform is subjected to an external force which exceeds one of the multiple resistance forces.

2. The six-axis parallel robot of claim 1, wherein each of the motor drivers is respectively configured to execute following actions:
receiving an external operation to set the target posture of the moving platform; and
receiving the external operation to set the multiple resistance forces of the moving platform relative to multiple directions, wherein the multiple resistance forces include three-axis forces and three-axis torques on a Cartesian coordinate system.

3. The six-axis parallel robot of claim 1, wherein each of the motor drivers is respectively configured to execute following actions to implement the action e):
action e1) continuously monitoring a change of the linear displacement of the corresponding linear motor;
action e2) determining whether the external force exceeds one of the multiple resistance forces;
action e3) controlling the corresponding linear motor to retract to perform the compliant motion in response to the external force exceeding one of the multiple resistance forces;
action e4) determining whether the change of the linear displacement of the corresponding linear motor exceeds a threshold; and
action e5) issuing a warning signal to stop moving when the change of the linear displacement of the corresponding linear motor exceeds the threshold.

4. The six-axis parallel robot of claim 1, wherein each of the motor drivers is respectively configured to execute following actions to implement the action a):
inputting the target posture of the moving platform relative to a base platform coordinate system, a first distance between a central point of the moving platform and each of the first joint components, a second distance between a central point of the base platform and each of the second joint components, a first angle representing half the value of an angle between two closest first joint components on the moving platform, and a second angle representing half the value of an angle between two closest second joint components on the base platform;
calculating a second coordinate position of each of the second joint components on the base platform coordinate system based on the second distance and the second angle;
calculating a first coordinate position of each of the first joint components on the base platform coordinate system based on the first distance and the first angle; and
based on the target posture of the moving platform relative to the base platform coordinate system, sequentially performing a coordinate transformation matrix multiplication on the first coordinate position of each of the first joint components, and taking a Euclidean distance with each corresponding second joint component to obtain the linear displacement of each corresponding linear actuator.

5. The six-axis parallel robot of claim 1, wherein each of the motor drivers is respectively configured to execute following actions to implement the action b):
action b1) inputting the target posture of the moving platform and inputting a preset minute gain change amount;
action b2) creating a posture array [X Y Z A B C]^{T}, wherein X, Y, and Z are positions of corresponding end points of the moving platform on an X-axis, a Y-axis, and a Z-axis, and A, B, and C represent Euler angles, and T represents transpose;
action b3) adding the minute gain change amount to a value of any of multiple matrix elements in the posture array;
action b4) respectively calculating a linear displacement before changing of the corresponding linear actuator under the target posture through the inverse kinematics calculation, and calculating a linear displacement post changing of the linear actuator corresponding to a changed posture after adding the minute gain change amount;
action b5) calculating a difference based on the linear displacement before changing and the linear displacement post changing, and calculating a final value of a matrix element in the Jacobian matrix based on the difference and value of the matrix element obtained in the action b3); and
action b6) repeating the action b3) through the action b5) for six times until the final value of six matrix elements in the Jacobian matrix are obtained to complete the Jacobian matrix.

6. The six-axis parallel robot in claim 5, wherein each of the motor drivers is respectively configured to execute following actions to implement the action c):
obtaining an equivalent total mass of the moving platform, an equivalent centroid vector of the moving platform, an X-axis direction component, a Y-axis direction component, and a Z-axis direction component of an equivalent external force on the moving platform, an equivalent torque vector on the moving platform, and a vector matrix formed by the equivalent external force and the equivalent torque vector;
obtaining the target posture and the linear displacement of the corresponding linear actuator to calculate the Jacobian matrix; and
calculating a linear thrust vector that the corresponding linear actuator needs to follow to maintain the moving platform at the target posture based on a first formula: f=J^{T}F=J^{T} (F+ [symbol] ×m\vec{g}), wherein f represents the linear thrust vector of each of the linear actuators, J^{T} represents the Jacobian matrix, F represents the vector matrix, [symbol] represents the equivalent centroid vector, m represents the equivalent total mass, \vec{g} represents a gravitational vector.

7. A compliant motion method for a six-axis parallel robot, being applied to the six-axis parallel robot having a moving platform, a base platform, multiple first joint components respectively arranged on a first surface of the moving platform, multiple second joint components respectively arranged on a second surface of the base platform, and six linear actuators respectively arranged between the moving platform and the base platform through the multiple first join components and the multiple second joint components, wherein the moving platform has a target posture and multiple resistance forces relative to multiple directions, each of the linear actuators respectively has a linear motor and a motor driver, and the compliant motion method comprising following steps:
step a) performing an inverse kinematics calculation based on the target posture by each of the motor drivers to obtain a linear displacement for each of the linear actuators to follow with to maintain the moving platform at the target posture and generating a position command correspondingly;
step b) calculating a Jacobina matrix based on the target posture by each of the motor drivers;
step c) calculating a force distribution of each of the six linear actuators based on the Jacobian matrix and the multiple resistance forces by each of the motor drivers and generating a force command correspondingly;
step d) controlling a corresponding linear motor based on the position command and the force command by each of the motor drivers to maintain the moving platform at the target posture; and
step e) controlling each of the linear actuators to perform a compliant motion by each of the motor drivers when the moving platform is subjected to an external force which exceeds one of the multiple resistance forces.

8. The compliant motion method of claim 7, further comprising following steps before the step a):
step a01) receiving an external operation by each of the motor drivers to set the target posture of the moving platform; and
step a02) receiving the external operation by each of the motor drivers to set the multiple resistance forces of the moving platform relative to multiple directions, wherein the multiple resistance forces include three-axis forces and three-axis torques on a Cartesian coordinate system.

9. The compliant motion method of claim 7, wherein the step e) comprises:
step e1) continuously monitoring a change of the linear displacement of the corresponding linear motor;
step e2) determining whether the external force exceeds one of the multiple resistance forces;
step e3) controlling the corresponding linear motor to retract to perform the compliant motion in response to the external force exceeding one of the multiple resistance forces;
step e4) determining whether the change of the linear displacement of the corresponding linear motor exceeds a threshold; and
step e5) issuing a warning signal to stop moving when the change of the linear displacement of the corresponding linear motor exceeds the threshold.

10. The compliant motion method of claim 7, wherein the step a) comprises:
step a1) inputting the target posture of the moving platform relative to a base platform coordinate system, a first distance between a central point of the moving platform and each of the first joint components, a second distance between a central point of the base platform and each of the second joint components, a first angle representing half the value of an angle between two closest first joint components on the moving platform, and a second angle representing half the value of an angle between two closest second joint components on the base platform;
step a2) calculating a second coordinate position of each of the second joint components on the base platform coordinate system based on the second distance and the second angle;
step a3) calculating a first coordinate position of each of the first joint components on the base platform coordinate system based on the first distance and the first angle; and
step a4) based on the target posture of the moving platform relative to the base platform coordinate system, sequentially performing a coordinate transformation matrix multiplication on the first coordinate position of each of the first joint components, and taking a Euclidean distance with each corresponding second joint component to obtain the linear displacement of each corresponding linear actuator.

11. The compliant motion method of claim 7, wherein the step b) comprises:
step b1) inputting the target posture of the moving platform and inputting a preset minute gain change amount;
step b2) creating a posture array [X Y Z A B C]^{T}, wherein X, Y, and Z are positions of corresponding end points of the moving platform on an X-axis, a Y-axis, and a Z-axis, and A, B, and C represent Euler angles, and T represents transpose;
step b3) adding the minute gain change amount to a value of any of multiple matrix elements in the posture array;
step b4) respectively calculating a linear displacement before changing of the corresponding linear actuator under the target posture through the inverse kinematics calculation, and calculating a linear displacement post changing of the linear actuator corresponding to a changed posture after adding the minute gain change amount;
step b5) calculating a difference based on the linear displacement before changing and the linear displacement post changing, and calculating a final value of a matrix element in the Jacobian matrix based on the difference and value of the matrix element obtained in the step b3); and
step b6) repeating the step b3) through the step b5) for six times until the final value of six matrix elements in the Jacobian matrix are obtained to complete the Jacobian matrix.

12. The compliant motion method of claim 11, wherein the step c) comprises:
step c1) obtaining an equivalent total mass of the moving platform, an equivalent centroid vector of the moving platform, an X-axis direction component, a Y-axis direction component, and a Z-axis direction component of an equivalent external force on the moving platform, an equivalent torque vector on the moving platform, and a vector matrix formed by the equivalent external force and the equivalent torque vector; and
step c2) obtaining the target posture and the linear displacement of the corresponding linear actuator to calculate the Jacobian matrix; and
step c3) calculating a linear thrust vector that the corresponding linear actuator needs to follow with to maintain the moving platform at the target posture based on a first formula: f=J^{T}F=J^{T} (F+ [symbol] ×m\vec{g}), wherein f represents the linear thrust vector of each of the linear actuators, J^{T} represents the Jacobian matrix, F represents the vector matrix, [symbol] represents the equivalent centroid vector, m represents the equivalent total mass, \vec{g} represents a gravitational vector.
